(19) United States
(12) Patent Application Publication
(10) Pub. No.: US 2023/0214064 A1
(43) Pub. Date: Jul. 6, 2023

(54) ADAPTIVE USER INTERFACES FOR WEARABLE DEVICES

(71) Applicant: Meta Platforms Technologies, LLC, Menlo Park, CA (US)

(72) Inventors: Nan Wang, Sunnyvale, CA (US); Doruk Senkal, Redmond, WA (US); Sebastian Sztuk, San Jose, CA (US); Johana Gabriela Coyoc Escudero, Union City, CA (US); Bo Liu, Fremont, CA (US); Kirsten Kaplan, Redmond, WA (US); Hind Hobeika, San Francisco, CA (US)

(21) Appl. No.: 18/059,860

(22) Filed: Nov. 29, 2022

Related U.S. Application Data
(60) Provisional application No. 63/296,399, filed on Jan. 4, 2022.
(60) Provisional application No. 63/296,401, filed on Jan. 4, 2022.
(60) Provisional application No. 63/311,788, filed on Feb. 18, 2022.

(51) Int. Cl. G06F 3/044; H04B 1/3827

(52) U.S. Cl. CPC G06F 3/044; H04B 1/3827

(57) ABSTRACT

A device is provided, including a frame, providing mechanical support to at least two eyepieces, a capacitive sensor mounted on the frame, an inertial measurement sensor mounted on the frame, and a flexible circuit component inside the frame and electrically coupling the capacitive sensor and the inertial measurement sensor with a processor circuit and a memory circuit inside the frame. A method for using the above device is also provided.

### BACKGROUND

The present disclosure is related and claims priority under 35 U.S.C. § 119(e) to U.S. Prov. Appln. No. 63/311,788, entitled ADAPTIVE USER INTERFACES FOR WEARABLE DEVICES, to Nan Wang et al., filed on Feb. 18, 2022, to U.S. Prov. Appln. No. 63/296,399, entitled ADAPTIVE SENSORS TO ASSESS USER CONDITION FOR WEARABLE DEVICES, to Doruk Senkal, et al., filed on Jan. 4, 2022, and to U.S. Prov. Appln. No. 63/296,401, entitled ADAPTIVE OPTICAL AND ELECTRICAL SENSORS TO ASSESS USER CONDITION FOR WEARABLE DEVICES to Kirsten KAPLAN et al., filed on Jan. 4, 2022, the contents of which applications are hereinafter incorporated by reference in their entirety for all purposes.

### BACKGROUND

### Field

The present disclosure is directed to user interfaces for wearable devices. More specifically, embodiments as disclosed herein are directed to adaptive user interfaces in smart glass devices used with immersive reality applications.

### Related Art

In the field of wearable devices, physical user interfaces are critical to have a seamless and likeable experience for users that is minimally invasive and rarely produces false positives. However, to achieve such operation capacity, systems such as capacitive touch sensors typically involve complex electronic circuitry that constrains the form factor and weight of the device, and its power consumption efficiency.

### SUMMARY

In a first embodiment, a device includes a frame, providing mechanical support to at least two eyepieces, a capacitive sensor mounted on the frame, an inertial measurement sensor mounted on the frame, and a flexible circuit component inside the frame and electrically coupling the capacitive sensor and the inertial measurement sensor with a processor circuit and a memory circuit inside the frame.

In a second embodiment, a computer-implemented method includes receiving, from a touch sensor mounted on a frame of a headset, a first touch signal above a first threshold value, receiving, from an inertial measurement unit mounted on the frame of the headset, a motion signal indicative of a motion of the headset, and identifying a user command to the headset based on a time overlap between the first touch signal and the motion signal.

In a third embodiment, a computer-implemented method includes receiving a signal from a sensor, the signal being indicative of a position and a motion of a user of a wearable device, determining, based on the signal, an activity that the user is engaged in, and assessing an intensity value to the activity based on an attribute extracted from the signal.

In other embodiments, a non-transitory, computer-readable medium stores instructions which, when executed by a processor, cause a computer to perform a method. The method includes receiving, from a touch sensor mounted on a frame of a headset, a first touch signal above a first threshold value, receiving, from an inertial measurement unit mounted on the frame of the headset, a motion signal indicative of a motion of the headset, and identifying a user command to the headset based on a time overlap between the first touch signal and the motion signal.

In yet other embodiments, a system includes a first means for storing instructions and a second means for executing the instructions to cause the system to perform a method. The method includes receiving, from a touch sensor mounted on a frame of a headset, a first touch signal above a first threshold value, receiving, from an inertial measurement unit mounted on the frame of the headset, a motion signal indicative of a motion of the headset, and identifying a user command to the headset based on a time overlap between the first touch signal and the motion signal.

These and other embodiments will become clear to one of ordinary skill in the art in view of the following.

### BRIEF DESCRIPTION OF THE FIGURES

FIG. 1 illustrates including one or more wearable devices coupled to one another, to a mobile device, a remote server and to a database, according to some embodiments.

FIG. 2 illustrates capacitive sensors for a user interface in a smart glass, according to some embodiments.

FIG. 3 illustrates different signals from a capacitive sensor, an IMU sensor (e.g., an accelerometer), and a tap sensor received in a span of time, according to some embodiments.

FIG. 4 illustrates another configuration with different signals from a capacitive sensor, an IMU sensor, and a tap sensor received in a span of time, according to some embodiments.

FIG. 5 illustrates different waveforms provided by an IMU sensor enabling identification of a light single tap or a light swipe, according to some embodiments.

FIG. 6 illustrates a block diagram of a flex circuit used in a smart glass (e.g., for at least one of the temple arms), according to some embodiments.

FIG. 7 illustrates some of the circuitry in a capacitive gesture sensor and processor, and a contact sensor and processor within the flex circuit, according to some embodiments.

FIG. 8 illustrates different configurations, within the flex circuit, of a sensor layer and a shield layer, according to some embodiments.

FIGS. 9A-9D illustrate contact sensors to prevent false positive signals in user inputs from a smart glass, according to some embodiments.

FIG. 10 illustrates a smart glass including a gyroscope and an IMU sensor, according to some embodiments.

FIGS. 11A-11H illustrate sensor signals from a smart glass when the user performs or adopts different actions and stances, according to some embodiments.

FIG. 12 illustrates a fitness application configured to measure and display for the user an intensity level for any given activity, according to some embodiments.

FIG. 13 is a flow chart illustrating steps in a method 1300 for identifying a user command in a headset, according to some embodiments.

FIG. 14 is a flowchart illustrating steps in a method for assessing a user condition with sensors mounted on a wearable device, according to some embodiments.

FIG. 15 is a flowchart illustrating steps in a method 1500 for assessing a user condition with sensors mounted on a wearable device, according to some embodiments.

FIG. 16 is a block diagram illustrating an exemplary computer system with which headsets and other client devices, and methods can be implemented, according to some embodiments.

In the figures, elements having the same or similar reference numeral are associated with the same or similar attributes and features, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

### General Overview

Physical capacitive touch interfaces are a primary interaction modality for enhanced reality applications, including virtual reality (VR) and augmented reality (AR). Accordingly, in embodiments disclosed herein, devices such as smart glasses include highly sensitive capacitive touch sensors combined with accelerometers, optical proximity sensors, and hinge hall sensors (e.g., to determine whether the smart glass is in use or not) and other inertial measurement units (IMUs), to ensure that tapping and swiping actions from the user are valid user inputs to the smart glass.

In some embodiments, capacitive touch sensors may be configured as linear arrays (one-dimensional, or 1D) of multiple capacitive cells, to detect not only tapping actions, but also swiping actions by the user, including swipe direction. Some embodiments may further include two-dimensional (2D) arrays of capacitive cells, which can be configured to detect a wider variety of swiping motions and directions, offering a menu of instructions and commands accessible to the user. In addition, single capacitive cells may be configured as one-point contact sensors in different parts of a smart glass to provide a secondary verification signal for smart glass usage and proper wearing by the user.

### Example System Architecture

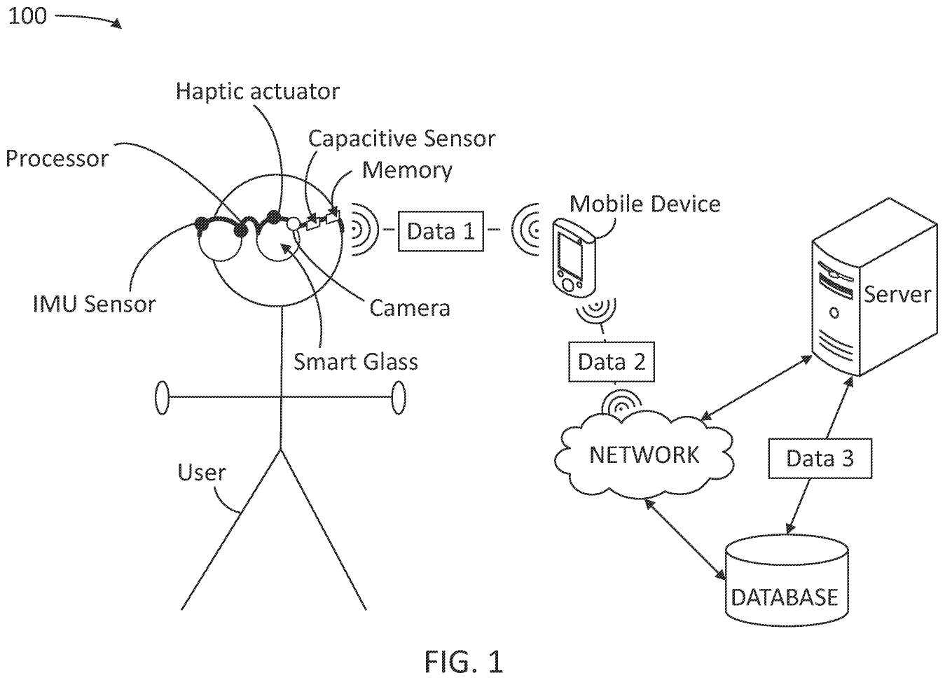

FIG. 1 illustrates an architecture 100 including one or more wearable devices coupled to one another, to a mobile device, a remote server and to a database, according to some embodiments. The wearable devices may include a smart glass or headset configured for AR/VR applications, and the mobile device may be a smart phone, all of which may communicate with one another via wireless communications and exchange a first dataset (e.g., “Data 1”). Data 1 may include a recorded video, audio, or some other file or streaming media. The user of the wearable device is also the owner or is associated with a mobile device. In some embodiments, the smart glass may directly communicate with the remote server, the database, or any other client device (e.g., a smart phone of a different user, and the like) via the network. The mobile device may be communicatively coupled with a remote server and a database via a network, and transmit/share information, files, and the like with one another (e.g., Data 2 and Data 3).

In some embodiments, the smart glass or headset may include multiple sensors such as IMUs, gyroscopes, microphones, cameras, and capacitive sensors configured as touch interfaces for the user. Other touch sensors may include a pressure sensor, a thermometer, and the like. In some embodiments, the smart glass may also include a haptic actuator to recreate a sense of touch to the user, for a VR/AR application.

In addition, the smart glass, and any other wearable device, or the mobile device may include a memory circuit storing instructions, and a processor circuit configured to execute the instructions to cause the smart glass to perform, at least partially, some of the steps in methods consistent with the present disclosure. In some embodiments, the smart glass, the mobile device, the server, and/or the database may further include a communications module enabling the device to wirelessly communicate with a remote server via the network. The smart glass may thus download a multimedia online content (e.g., Data 1) from the remote server, to perform at least partially some of the operations in methods as disclosed herein. In some embodiments, the memory may include instructions to cause the processor to receive and combine signals from the IMU sensors, microphones, capacitive sensors, and other contact sensors, avoid false positives and better assess user intentions and commands when a touch signal is received.

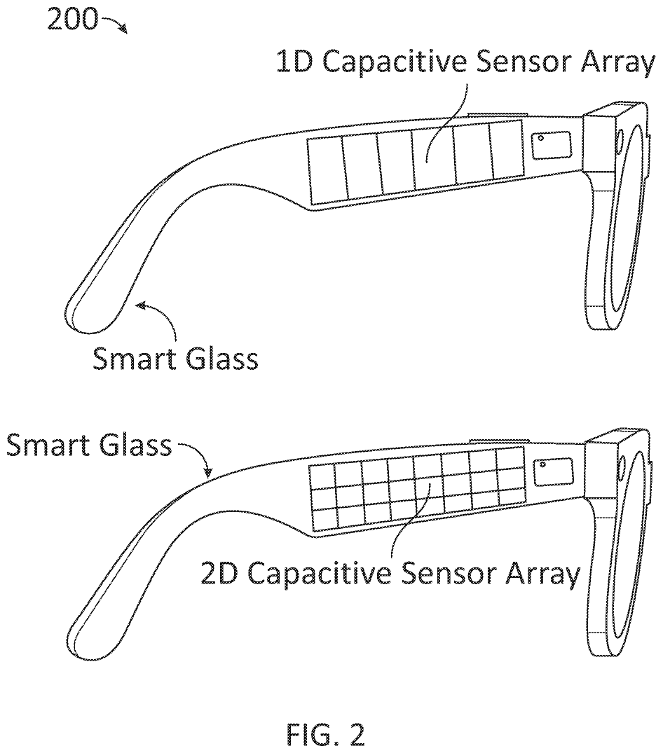

FIG. 2 illustrates capacitive sensors 200 for a user interface in a smart glass, according to some embodiments. In some embodiments, it is convenient that the capacitive sensors be arranged on the outside of the smart glass arm, to enable a larger displacement of the user touch (e.g., typically with the index finger). A one-dimensional (1D) capacitive sensor array may be configured as a linear array of capacitive pads or “pixels,” such that the user slides a finger in either direction to provide a desirable command. In some embodiments, the processor may identify the direction (e.g., left-right in the figure, or front-back relative to the user's head), length, and speed of the user slide, and the like.

A two-dimensional (2D) capacitive sensor array may allow a wider range of signals and commands for input (e.g., gestures), and a better resolution and fidelity for sensing (diagonal swipes, zig-zag swipes), thus expanding the menu of instructions. For example, in some embodiments, a 2D capacitive sensor may be included for scrolling over a website. The website may be displayed on the eyepieces of the smart glass by an application installed in the smart glass or in the mobile device, or in a watch or wrist-band device worn by the user. In some embodiments, 1D and/or 2D capacitive sensor arrays may be used to control the transparency level of the eyepieces, according to an ambient light level, to collect a camera capture (e.g., picture or video), or activate a virtual assistant in the display of the smart glass.

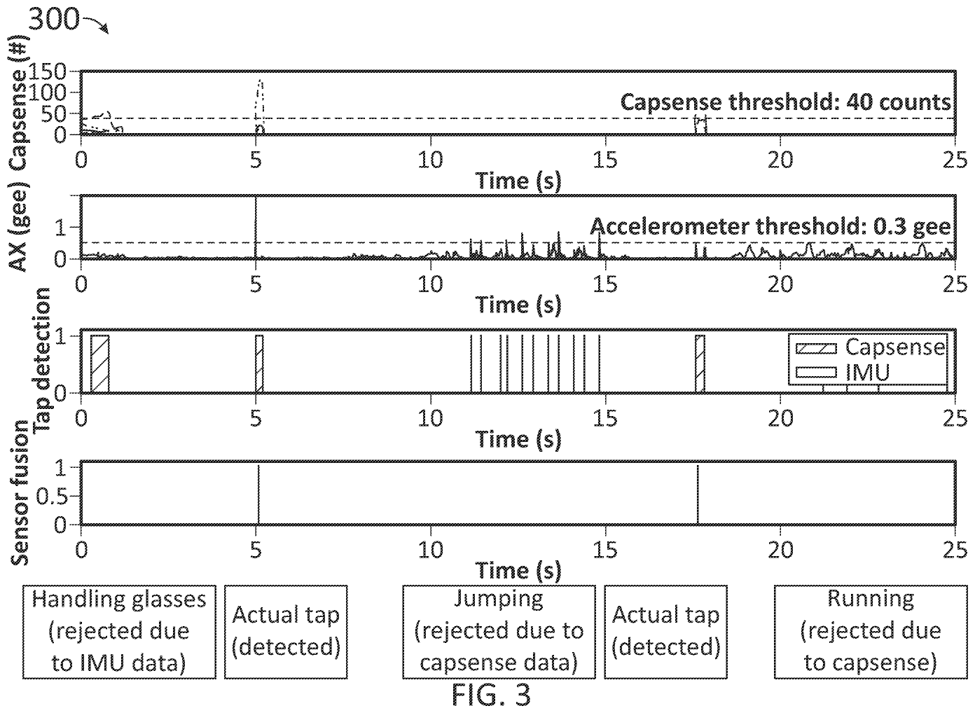

FIG. 3 illustrates different signals 300 from a capacitive sensor, an IMU sensor (e.g., an accelerometer), and a tap sensor received in a span of time, according to some embodiments. Based on a combination of the waveforms from each of the different sensors, the processor may be configured to assess which signal from the capacitive sensors corresponds to a valid, intentional user command. For example, the initial waveform captured by the capacitive sensor may be indicative that the user is handling the smart glasses before issuing a command, and thus may be rejected, in the absence of corroborative IMU data. The IMU sensor may be able to detect acceleration (e.g., in either one or each of the X, Y, or Z-directions), motion in general, and impact. To avoid cross-talk and false positives, in some embodiments it may be desirable to place the IMU sensor at a safe distance from the capacitive touch sensor. An actual tap from the user may be verified by a temporal overlap of the waveforms from the three sensors: capacitive, IMU, and tap. Other minor perturbations detected by the IMU sensor and the tap detector (e.g., jumping and tremors due to user locomotion, sneeze, small bumps, running, tripping, falling, and the like) may be discarded when they do not overlap capacitive sensor data, or because the cap sensing signal is below a pre-selected threshold.

The capacitive sensor threshold may be determined in number of counts, or bits, in a digitized signal. The IMU sensor may have a threshold determined in a “g-value” (e.g., acceleration in surface of earth gravity units, g=9.81 m/s²). In some embodiments, the signal from the capacitive sensor includes a waveform for each of the pads in the capacitive sensor.

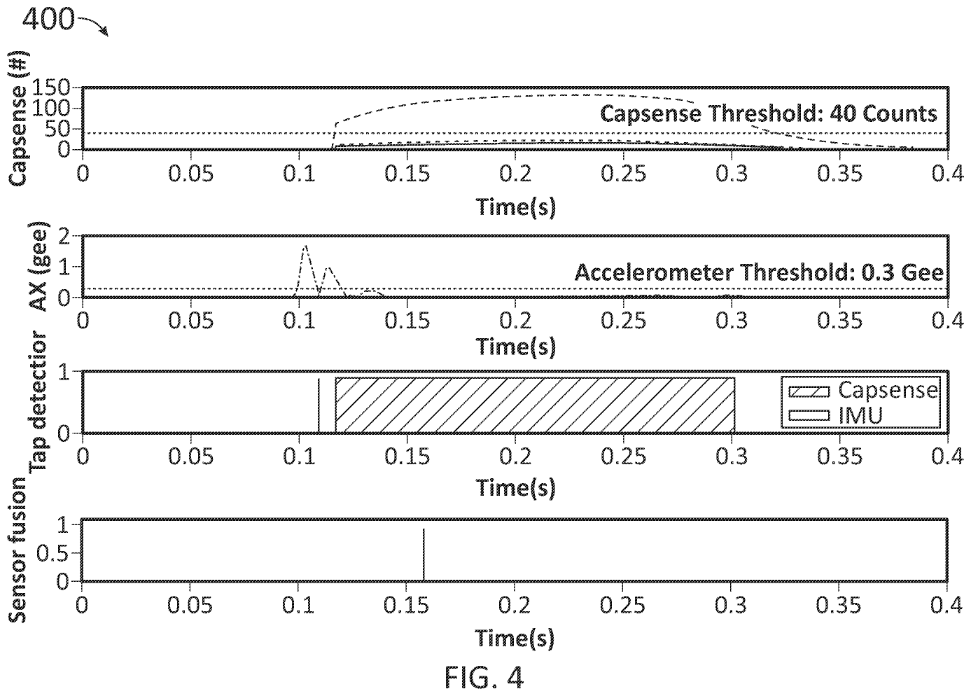

FIG. 4 illustrates another configuration with different signals 400 from a capacitive sensor, an IMU sensor, and a tap sensor received in a span of time, according to some embodiments. In the illustrated configuration, the combination of a long, capacitive sensing signal together with an initial IMU perturbation and a tap, indicates a tap-and-slide input from the user, which may be associated with a specific command. In some embodiments, it is challenging to identify and differentiate between a single tap and a swipe motion. For example, a light swipe can have a similar intensity level as the signal from running/jumping, unrelated to a user input. To resolve this, some embodiments use an IMU threshold that is low, at the risk of triggering the sensor at a higher rate than desirable.

Note that, in some embodiments, a tap and swipe motion is such that the tap signal is detected somewhat earlier than the capacitance sensor swipe, as expected for an intentional tap-and-swipe user interaction.

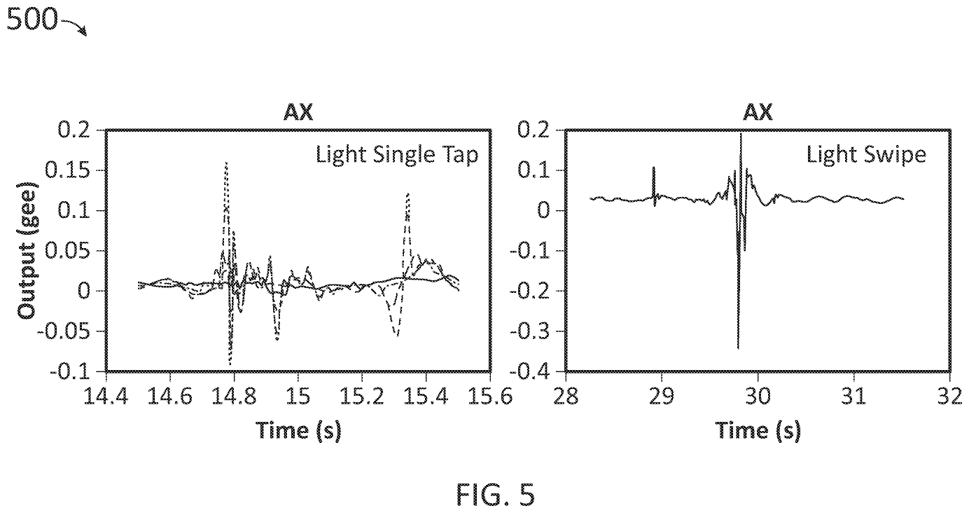

FIG. 5 illustrates different waveforms 500 provided by an IMU sensor enabling identification of a light single tap or a light swipe, according to some embodiments. Accordingly, in some embodiments, the processor may be configured to perform a pattern recognition for a full waveform. This approach may mitigate the false triggering of the IMU sensor, and in combination with a swipe signal from the capacitive sensor, a much more robust design is achieved. IMU sensors and gyroscopes, having three mutually orthogonal degrees of freedom may be used in some embodiments to detect specific head motions by the user, including directionality, such as a head nod: sideways, up and down, and the like.

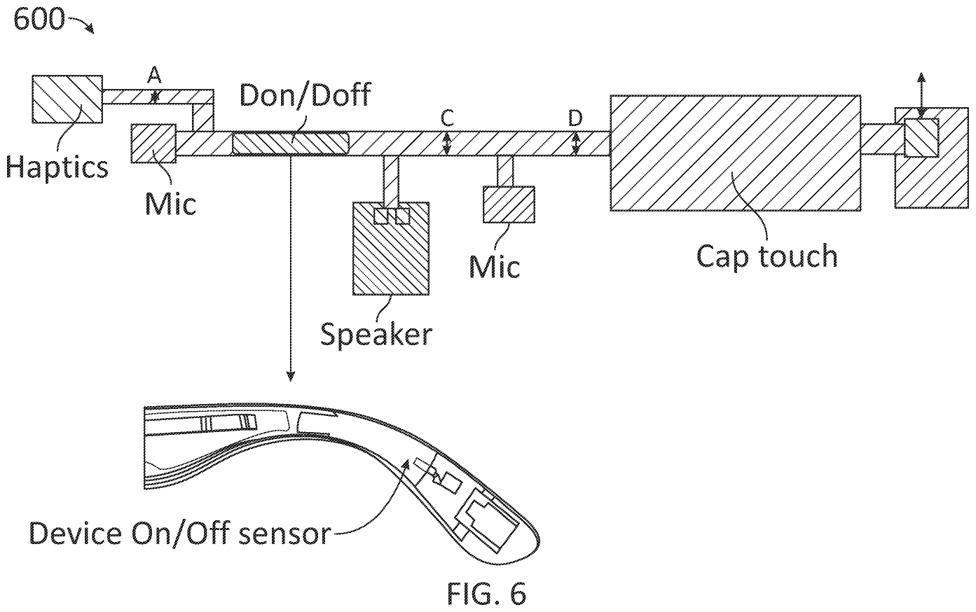

FIG. 6 illustrates a block diagram 600 of a flex circuit used in a smart glass (e.g., for at least one of the temple arms), according to some embodiments. Near the ear of the user, a touch/contact sensor may be used to determine whether the smart glass is on/off the user's head (e.g., whether the user is wearing and using the device). In some embodiments, a processor may be coupled to both the on/off sensor and the other capacitive sensors for tap/swipe input from the user. Note that the on/off contact sensor may be located on an inside portion of the temple arm (so that contact with the user's skin or hair is possible). Accordingly, the tap/swipe capacitive sensor may be disposed on the outside portion of the temple arm so that the user can have direct access with a pointer finger, while wearing the smart glasses.

In some embodiments, a single flex circuit may include the gesture sensor and the contact sensor, including other components such as the microphone, speaker, and haptics actuator. The capacitive sensor may be located close to the speaker, microphone, and/or haptic actuator (at about the ear level on the smart glass arm). In some embodiments, the capacitor sensor area may be up to 150 mm², or more.

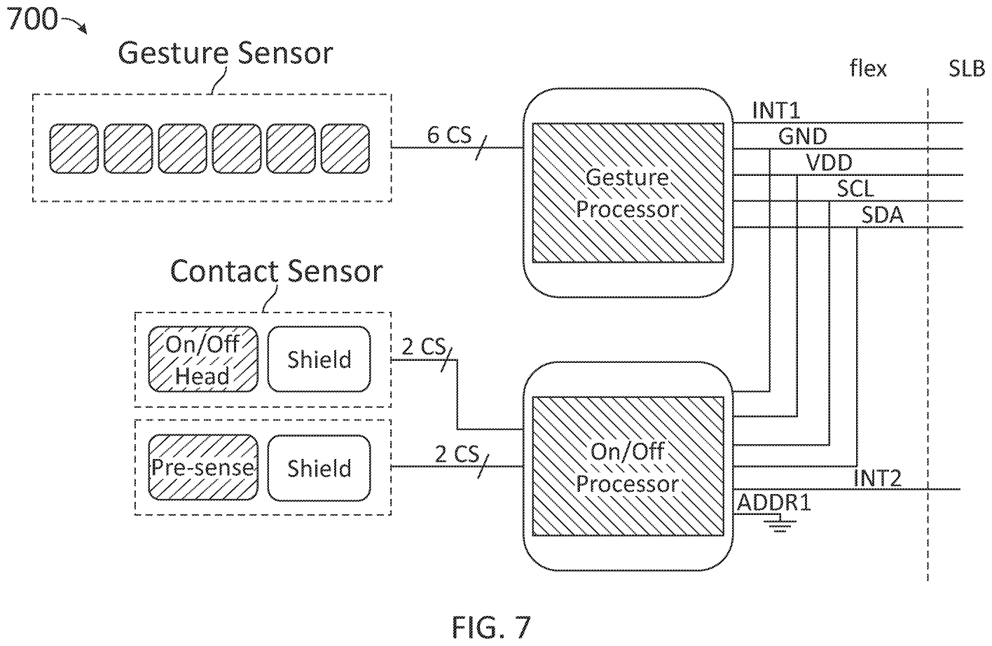

FIG. 7 illustrates some of the circuitry 700 in a capacitive gesture sensor and processor, and a contact sensor and processor within the flex circuit, according to some embodiments. The contact sensor may include a shield layer to avoid interference with the outside world (e.g., an external element inadvertently touching the sensor such as a hat, hair, clothing, other person, or object). In some embodiments, the gesture sensor and the contact sensor may be one and the same, but have separate channels for signal handling. In yet other embodiments, a gesture processor may be separate from the contact processor.

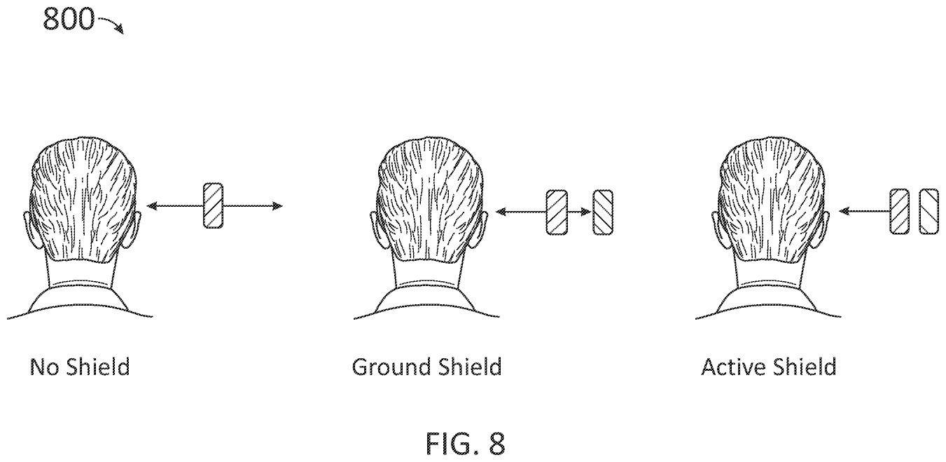

FIG. 8 illustrates different configurations 800, within the flex circuit, of a sensor layer and a shield layer, according to some embodiments. For example, some embodiments may include no shield layer, a ground shield layer, or an active shield layer.

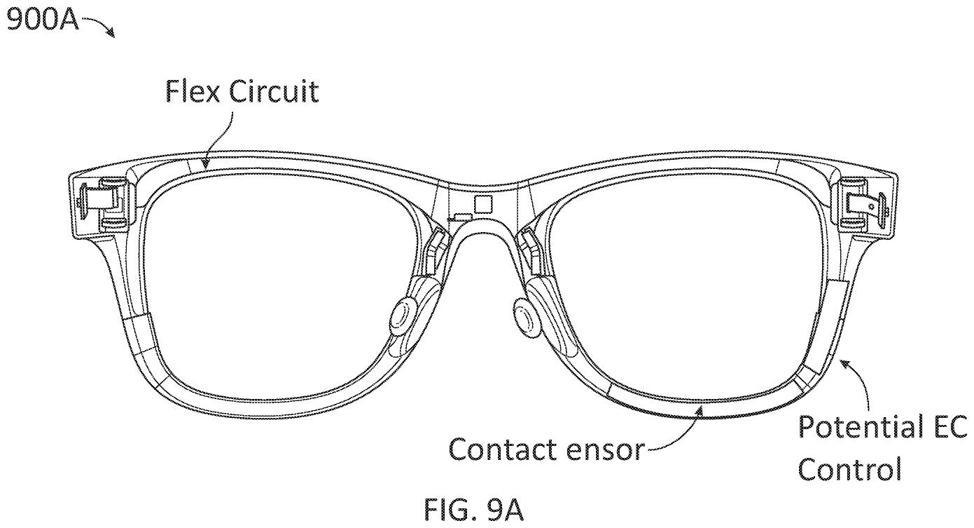

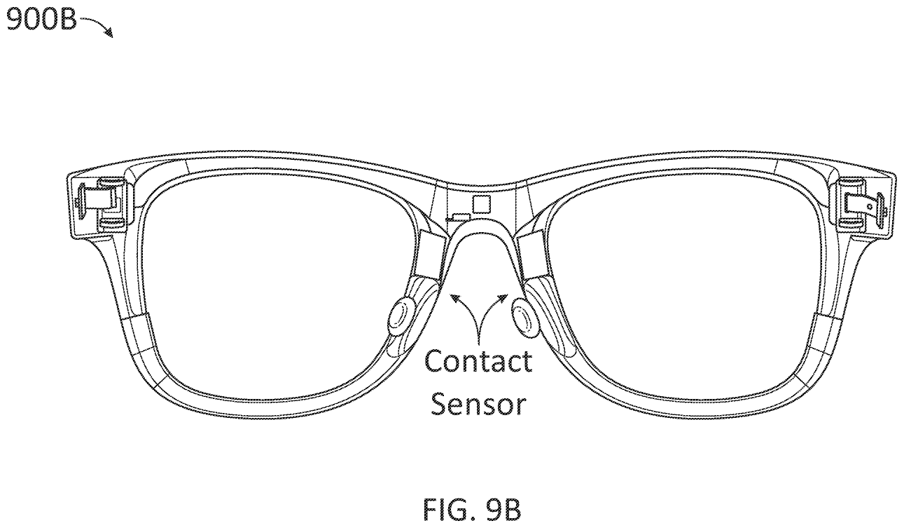

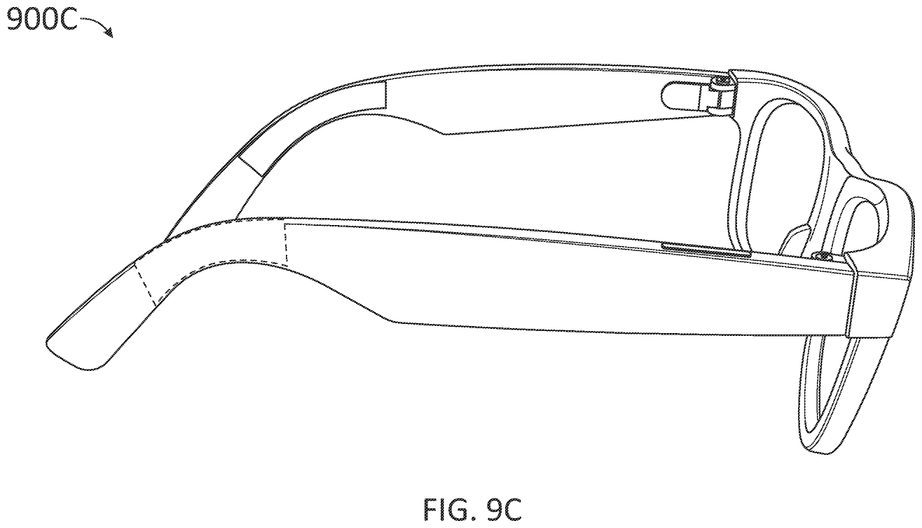

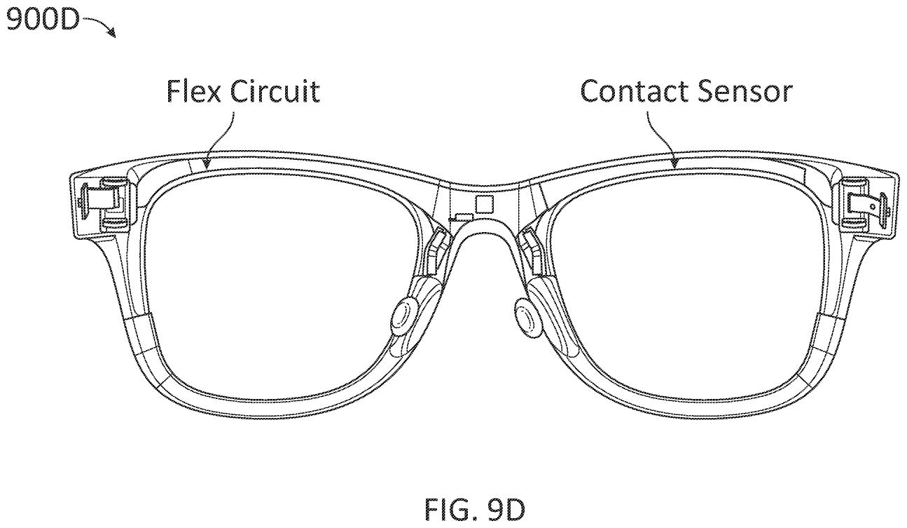

FIGS. 9A-9D illustrate contact sensors 900A, 900B, 900C, and 900D (hereinafter, collectively referred to as “contact sensors 900”) to prevent false positive signals in user inputs from a smart glass, according to some embodiments. The contact sensors may be disposed on the inside of the frame, touching or contacting the user's skin. Accordingly, to validate a gesture from a gesture sensor, the system may be configured to simultaneously or at least overlapping in time, receive a signal from one or more of the contact sensors illustrated in FIGS. 9A-9D. A processor may be electronically coupled via a flex circuit to provide power to, and receive the signals from, the contact sensors.

FIG. 9A illustrates contact sensor 900A on the bottom of at least one of the eyepieces. An electro-magnetic control may be disposed as illustrated in the figure.

FIG. 9B illustrates one or two contact sensors 900B disposed on the nose pad of the eyeglass (e.g., contact microphones), which is a convenient way to ensure that the smart glass is being worn and operated by the user (when combined with a gesture signal). In some embodiments, the two contact sensors may be located close to the nose pads, on the bridge joining the two eyepieces, which is an area of contact with the user's upper nose/lower forehead.

FIG. 9C illustrates one or two contact sensors 900C disposed close to the ear lobe or occipital area of the user (on the inside and/or the outside of the temple arm).

FIG. 9D illustrates contact sensor 900D on the eyebrow area of the frame (e.g., on the inside, facing the user's skin or eyebrow).

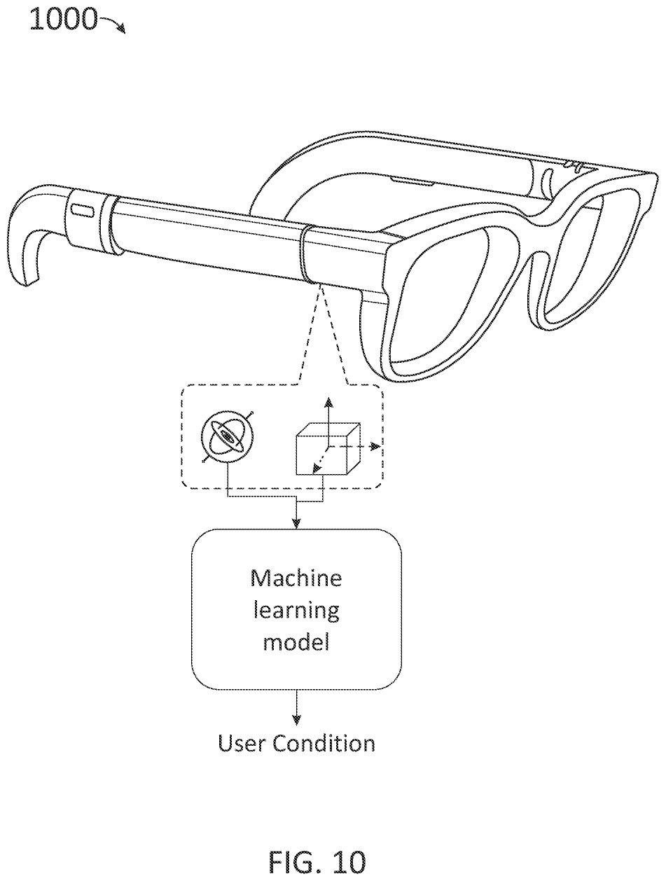

FIG. 10 illustrates a smart glass 1000 including a gyroscope and an IMU sensor, according to some embodiments. The gyroscope may provide information about an angular position of the smart glass (e.g., orientation relative to the vertical and angular speed), and the IMU sensor may provide information about position, speed, and acceleration of the smart glass. In some embodiments, the IMU sensor may include at least three accelerometers in mutually orthogonal directions. The signal from the three accelerometers can be integrated to determine a position and a speed of the user's head at any moment in time.

A machine learning model captures information collected by the gyroscope, the IMU sensor, and/or other sensors, to determine a user condition, and even to establish an intensity value to that condition. Some examples of user conditions evaluated according to embodiments disclosed herein may include whether the user is running, running fast, standing, sitting, laying down, and even the user's posture and for how long the user has maintained said condition.

In some embodiments, a second wearable device in a different body part of the user (e.g., a wrist-watch, wrist-band, arm-band, shoulder patch, ankle band, knee band or leg-band, and the like) may include a gyroscope and IMU sensors whose signals may indicate relative motion and pose between different body parts of the user. This information, together with additional data such as camera views or audio feedback (e.g., from one or more cameras and microphones on the one or more wearable devices including the smart glass), is used by the machine learning model to assess user's pose, activity, and intensity.

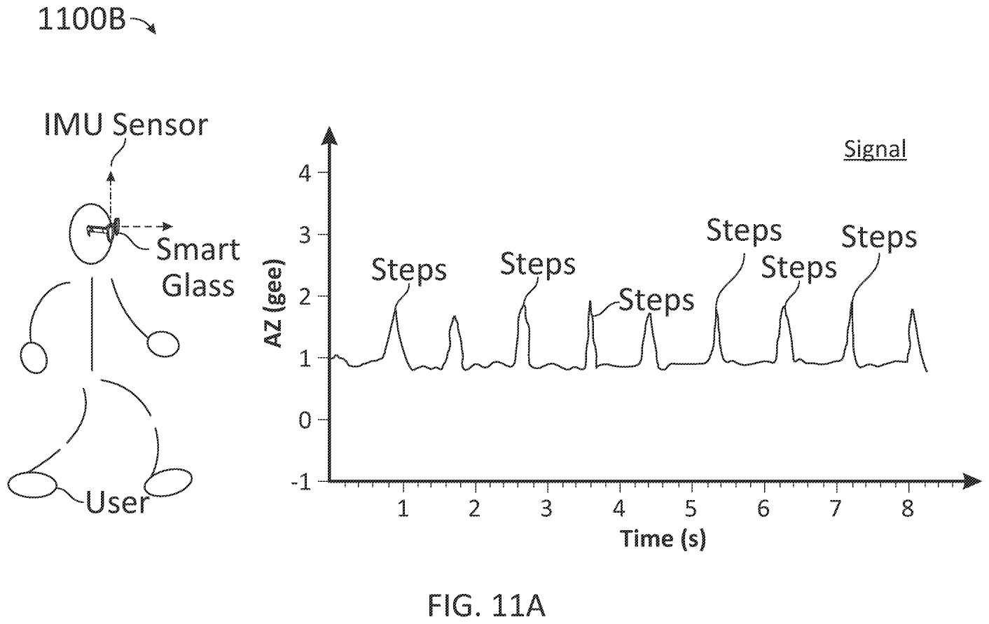

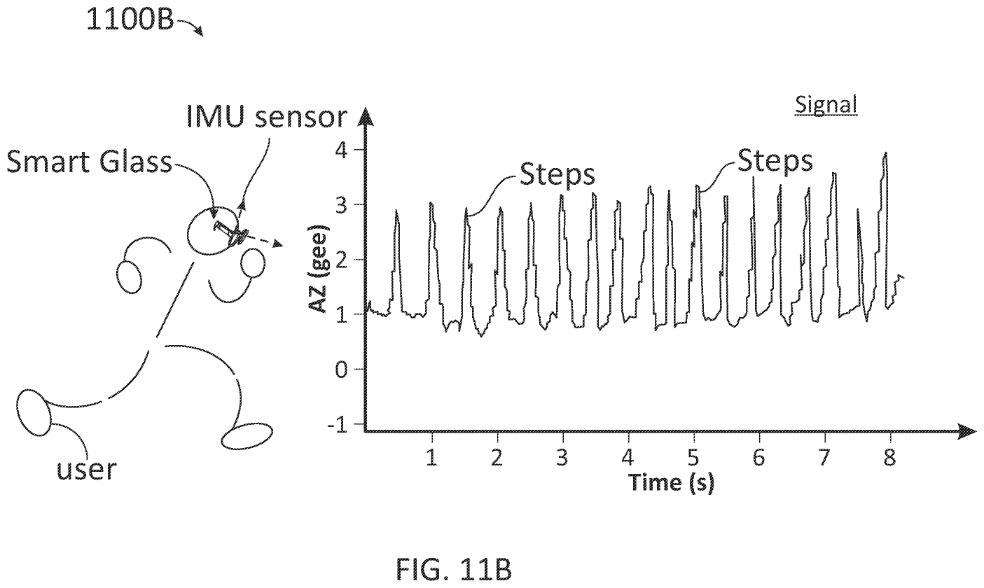

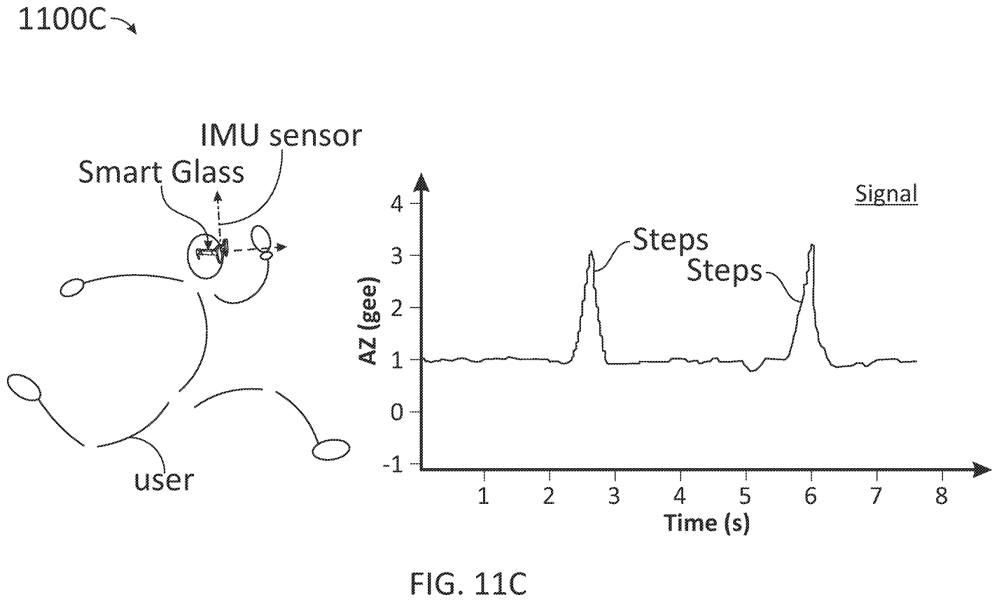

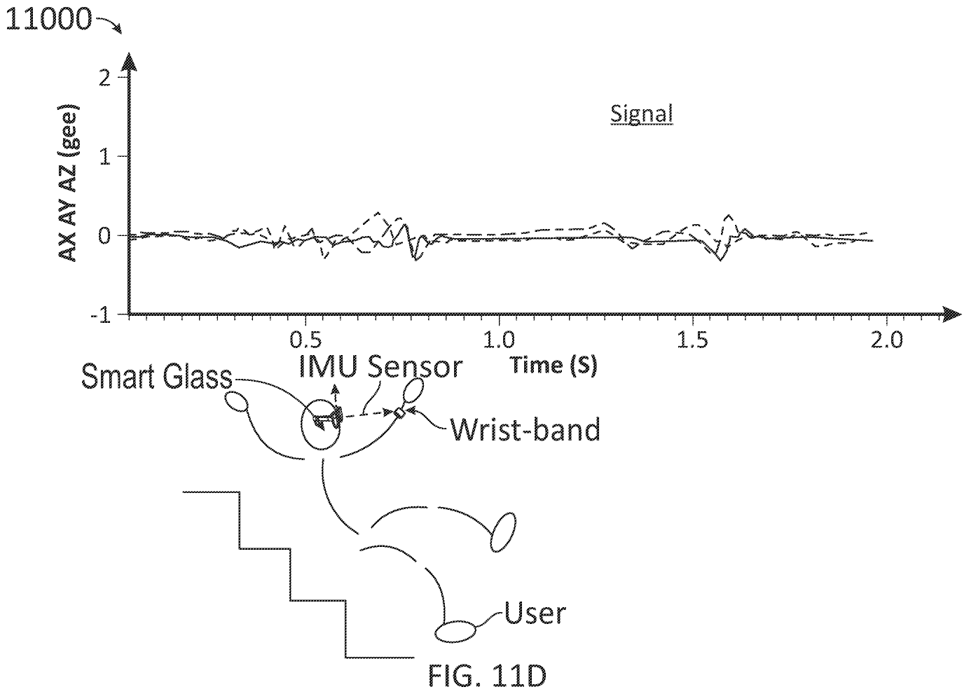

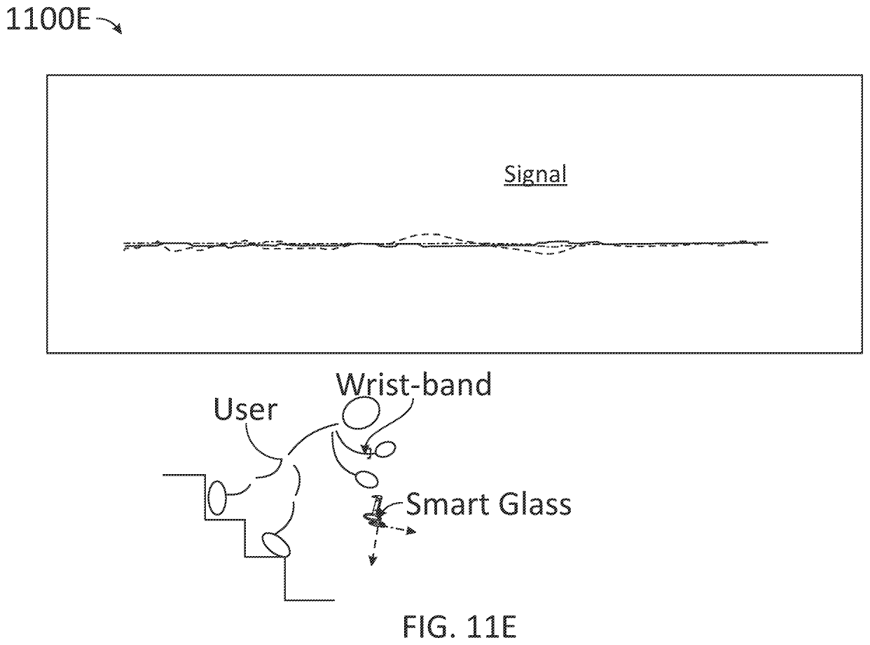

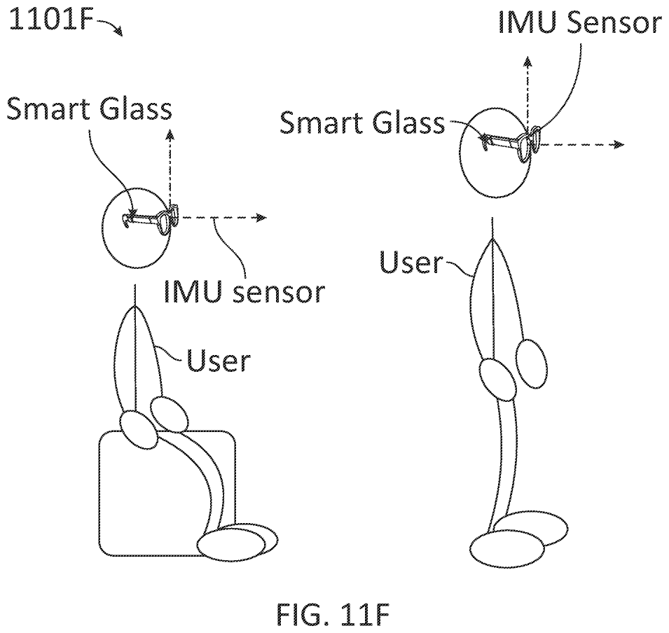

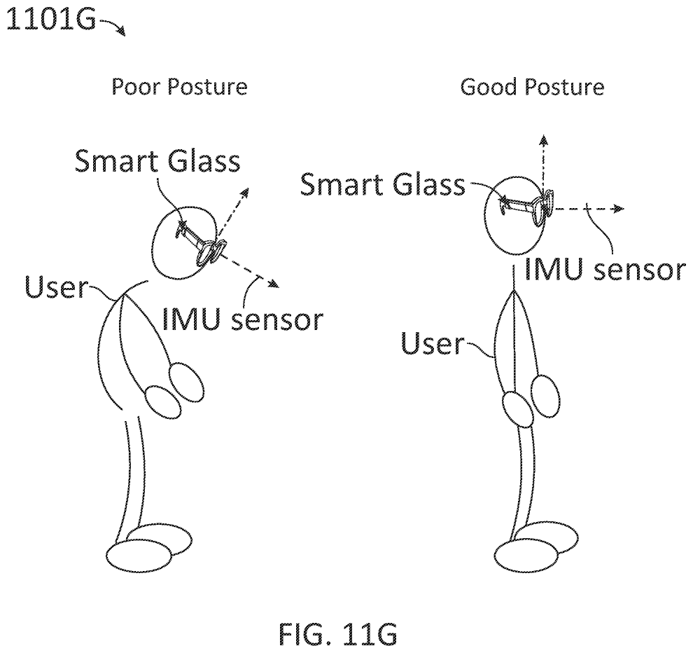

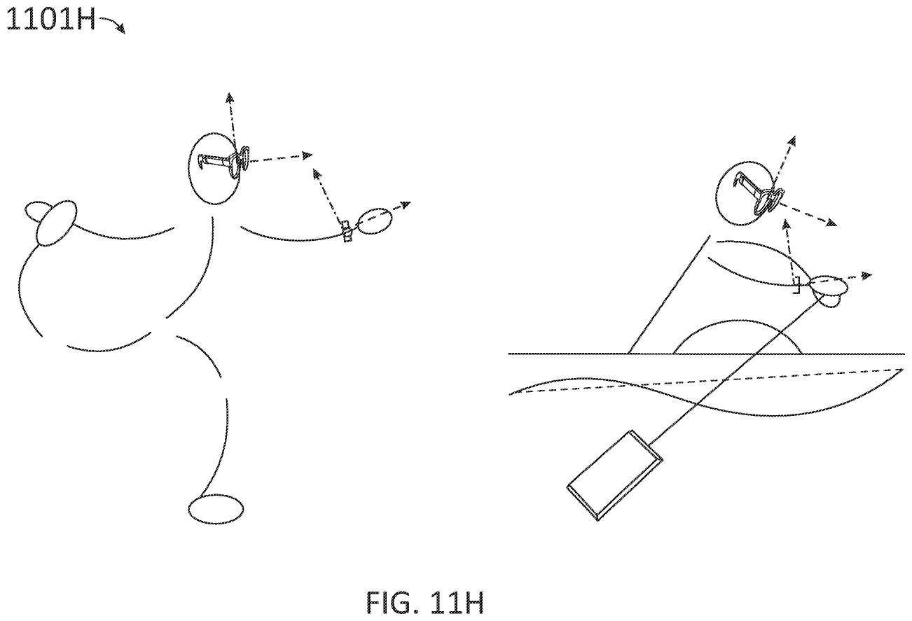

FIGS. 11A-11H illustrate sensor signals 1100A, 1100B, 1100C, 1100D, and 1100E (hereinafter, collectively referred to as “sensor signals 1100”), from a smart glasses when the user performs or adopts different actions and postures 1101F, 1101G, and 1101H (hereinafter, collectively referred to as “postures 1101”), according to some embodiments. Sensors signals 1100 may be provided by an IMU sensor.

Sensor signal 1100A is generated by a smart glass when the user walks in a given direction, at a constant pace, according to some embodiments. The spikes in the signal may be indicative of each single step taken by the user. Accordingly, in some embodiments, a data analysis algorithm may be used to read out the inter spike time-lapse, amplitude, and other features to ascertain certain attributes of the user behavior: how much energy is the user investing, is there any indication of stress, relaxation, and the like.

Sensor signal 1100B is generated by a smart glass when the user runs in a given direction, according to some embodiments. The spikes are more irregular in amplitude and occur at a higher frequency, indicating a greater intensity of the motion (e.g., the user is running), and perhaps a degree of stress in the user.

Sensor signal 1100C is generated by a smart glass when the user runs at a high pace in a given direction, according to some embodiments. Given the wider steps taken by the user in a fast gallop, the spacing between the signal spikes is less frequent, but seemingly more regular. In some embodiments, signals from other wearable devices may indicate the relative positioning between arms, legs, and head of the user, enabling the system to get a better assessment of the exact type of motion that the user is performing. In some embodiments, a machine learning algorithm may be implemented to determine each of the activity configurations in FIGS. 3-5 according to activity attributes (cf. table 1). In some embodiments, signal attributes from Table 1 may be combined with a global positioning service (GPS) to fine tune or pinpoint the location of the user within a building, a city block, and the like.

TABLE 1
Signal attributes and Activity condition

| Signal Attribute | Walking | Running | Jumping |
|---|---|---|---|
| Intensity | Low | High | High |
| Frequency | Medium | High | Low/single |

| | |
|---|---|
| Steps | Spikes |

Sensor signal 1100D is generated by a smart glass indicating a fall, according to some embodiments. In some embodiments, a machine learning algorithm may be trained to identify a fall and then take an emergency action if there is no ulterior movement or there is an abnormal movement from the user after the fall. For example, the smart glass may be configured to transmit an emergency signal to a remote server via the network (or the mobile device associated with the user, if available within reach of a wireless signal). In some embodiments, a wrist-band worn by the user may complement or supplement the signals provided by the sensors in the smart glass.

Sensor signal 1100E is generated by a smart glass indicating a drop, according to some embodiments. In some embodiments, a wrist-band worn by the user may complement or supplement the signals provided by the sensors in the smart glass.

User postures 1101F may be identified from sensor signals received from a smart glass, according to some embodiments. For example, by integrating the acceleration in a vertical direction, a relative height of the user may be identified (e.g., the user is sitting, or standing still). In some embodiments, the user height relative to the horizontal may be determined by a precise pressure measurement.

User postures 1101G may be identified from sensor signals received from a smart glass, according to some embodiments. In addition to position and pose, some embodiments may complement these sensor signals with a camera collected frame indicative of what is in the field of view of the smart glasses (e.g., the floor, the horizon, and the like). Accordingly, some postures may be identified as “good” or “poor,” and in some embodiments the smart glass, or an associated application in a mobile device, may indicate to the user that it has held a “bad” or incorrect, or unhealthy posture for over a pre-selected threshold of time.

User postures 1101H indicate activities that may be identified from sensor signals received from a smart glass in combination with at least one or more wearable device (e.g., a wrist-band). The two activities may be ballet-dancing and rowing, respectively. Accordingly, a machine learning algorithm may be trained to identify the relative motions of the limbs, and their speed, pace, and frequency, to identify the type of activity that the user is engaged in.

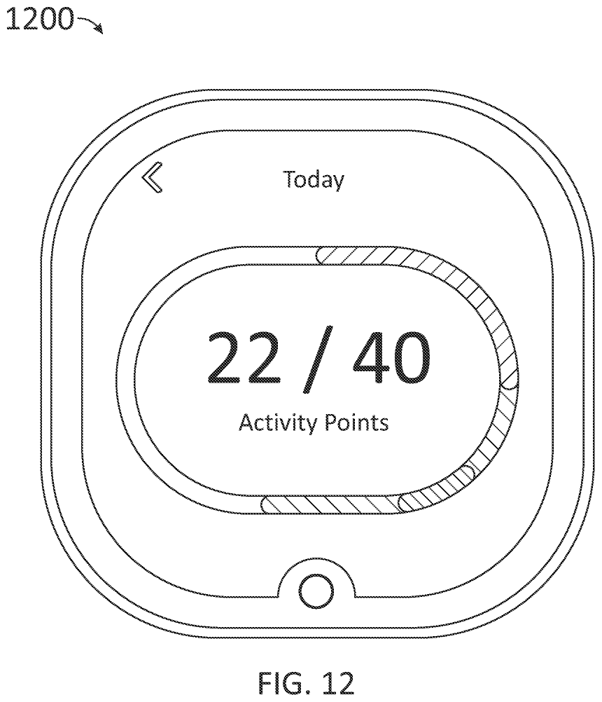

FIG. 12 illustrates a fitness application 1200 configured to measure and display for the user an intensity level for any given activity, according to some embodiments. For example, in some embodiments, the user may be part of a training group, or therapy group, or a single training plan with goals and objectives, wherein a point system may be allocated as follows:

$$α = {\sum }_{i}^{day , week} Activity level \times Duration \qquad ( 1 )$$

In some embodiments, the fitness application may be hosted in the mobile device by the remote server, and the mobile device collects the motion and activity data from the smart glass and the wearable devices (e.g., Data 1, cf. FIG. 1). In some embodiments, the fitness application may be installed in the smart glasses, or may be remotely running in the server with Data 1 and Data 2 transmitted via the mobile device to the server, to perform the calculations in Eq. 1. Table 2 below indicates certain activity or condition classifiers based on activity level calculated using Eq. 1, according to some embodiments.

TABLE 2

| Classifier | Sedentary | Walking | Running |
|---|---|---|---|
| Activity Level | 1 | 5 | 10 |

Eq. 1 may be an approximate proxy for the Metabolic Equivalent of Task (MET) x Duration of Activity. For example, regular cardiovascular activity can prevent or minimize the impact of serious or life-threatening medical conditions such as heart disease, stroke, diabetes, and cancer. Accordingly, a mobile application as disclosed herein may include IMU-based algorithms to help the user of the smart glasses track user activity habits and motivate regular exercises. The mobile application may include a graphical user interface (GUI) to illustrate to the user a real-time rendition of “activity point” status tracking and statistics report. To estimate activity points, the MET is estimated first. In some embodiments, a coarse-grained version of MET, such as “Activity Level,” can be estimated by activity recognition.

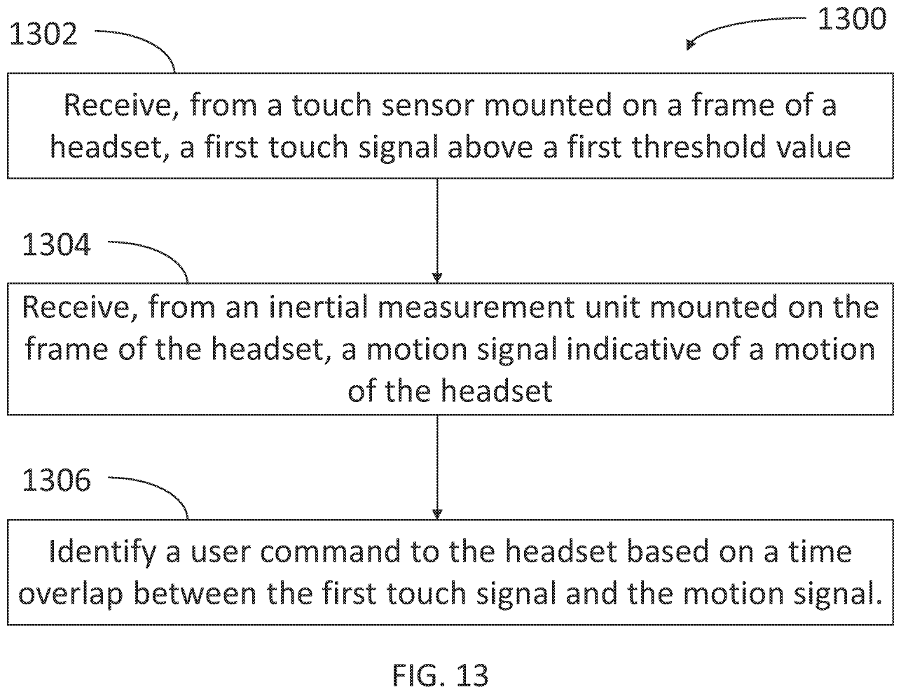

FIG. 13 is a flow chart illustrating steps in a method 1300 for identifying a user command in a headset, according to some embodiments. In some embodiments, at least one or more of the steps in method 1300 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 1300 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication—NFC—and the like). In some embodiments, a method consistent with the present disclosure may include one or more steps from method 1300 performed in any order, simultaneously, quasi-simultaneously, or overlapping in time.

Step 1302 includes receiving, from a touch sensor mounted on a frame of a headset, a first touch signal above a first threshold value. In some embodiments, step 1302 includes receiving a second touch signal from a contact sensor, the second touch signal indicative that the headset is worn properly, and wherein identifying the user command comprises verifying that the headset is worn properly.

Step 1304 includes receiving, from an inertial measurement unit mounted on the frame of the headset, a motion signal indicative of a motion of the headset. In some embodiments, step 1304 includes verifying that the motion signal is above a second threshold value.

Step 1306 includes identifying a user command to the headset based on a time overlap between the first touch signal and the motion signal. In some embodiments, the first touch signal is a swipe signal, and step 1306 includes identifying a speed and direction of the swipe signal to verify the user command to the headset. In some embodiments, step 1306 includes identifying the motion signal as a tap, and identifying the first touch signal as a swipe command subsequent to the tap.

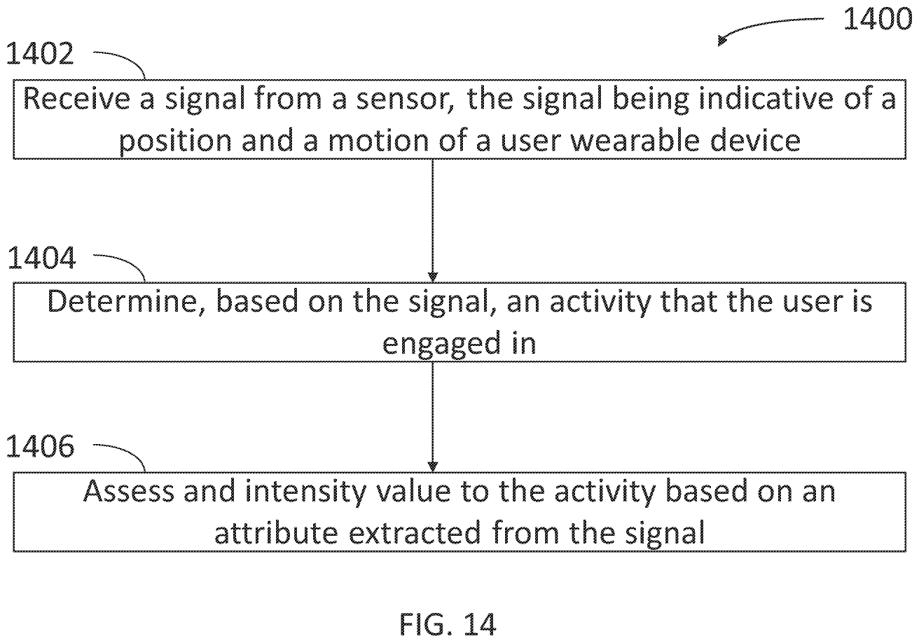

FIG. 14 is a flowchart illustrating steps in a method 1400 for assessing a user condition with sensors mounted on a wearable device, according to some embodiments. In some embodiments, at least one or more of the steps in method 1400 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 1400 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication—NFC—and the like). In some embodiments, a method consistent with the present disclosure may include one or more steps from method 1400 performed in any order, simultaneously, quasi-simultaneously, or overlapping in time.

Step 1402 includes receiving a signal from a sensor, the signal being indicative of a position and a motion of a user of a wearable device. In some embodiments, the wearable device is a smart glass and step 1402 includes receiving a signal indicative that the user is wearing the smart glass. In some embodiments, the wearable device includes a wrist-band device worn by the user, further including correlating the signal from the wrist-band device with a signal from a smart glass worn by the user.

Step 1404 includes determining, based on the signal, an activity that the user is engaged in. In some embodiments, step 1404 includes identifying a pose of the user based on the signal. In some embodiments, the sensor is a gyroscope, and the signal indicates an orientation of a user's body part relative to a vertical position, and step 1404 includes determining a user's pose based on the orientation of the user's body part. In some embodiments, the sensor is an inertial motion unit having an accelerometer in three mutually orthogonal directions, further including integrating an accelerometer signal to determine a position and a speed of a body part of the user.

Step 1406 includes assessing an intensity value to the activity based on an attribute extracted from the signal. In some embodiments, step 1406 includes extracting the attribute from the signal based on a pattern identified in the signal with a machine learning algorithm.

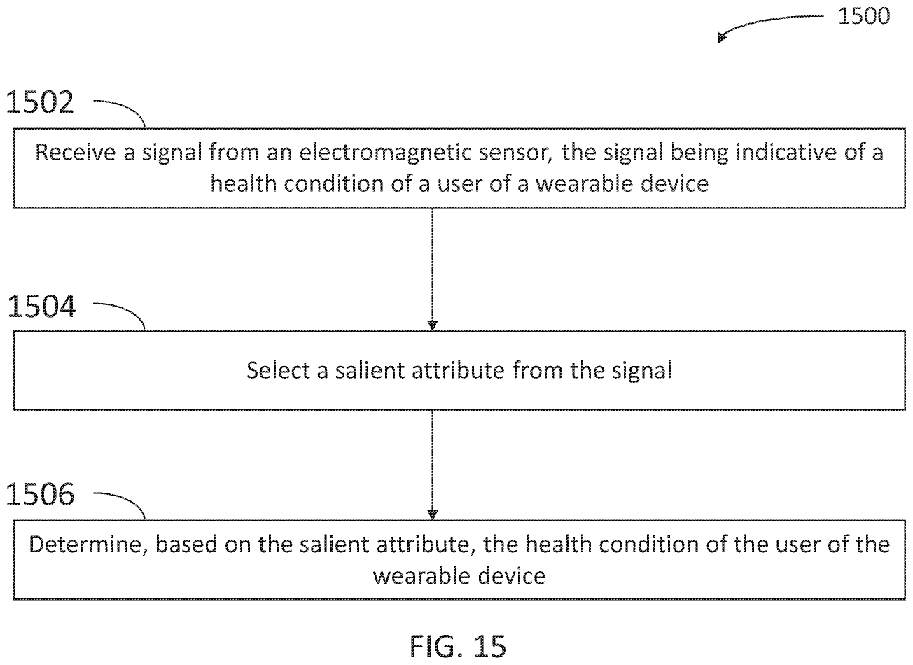

FIG. 15 is a flowchart illustrating steps in a method 1500 for assessing a user condition with sensors mounted on a wearable device, according to some embodiments. In some embodiments, at least one or more of the steps in method 1500 may be performed by a processor executing instructions stored in a memory in either one of a smart glass or other wearable device on a user's body part (e.g., head, arm, wrist, leg, ankle, finger, toe, knee, shoulder, chest, back, and the like). In some embodiments, at least one or more of the steps in method 1500 may be performed by a processor executing instructions stored in a memory, wherein either the processor or the memory, or both, are part of a mobile device for the user, a remote server or a database, communicatively coupled with each other via a network. Moreover, the mobile device, the smart glass, and the wearable devices may be communicatively coupled with each other via a wireless communication system and protocol (e.g., radio, Wi-Fi, Bluetooth, near-field communication—NFC—and the like). In some embodiments, a method consistent with the present disclosure may include one or more steps from method 1500 performed in any order, simultaneously, quasi-simultaneously, or overlapping in time.

Step 1502 includes receiving a signal from an electromagnetic sensor, the signal being indicative of a health condition of a user of a wearable device. In some embodiments, step 1502 includes selecting at least one photoplethysmography sensor that is active from multiple photoplethysmography sensors mounted on the wearable device. In some embodiments, step 1502 includes receiving a signal from a green light emitting diode in a first photoplethysmography sensor and receiving a signal from an infrared light emitting diode in a second photoplethysmography sensor.

Step 1504 includes selecting a salient attribute from the signal. In some embodiments, the electromagnetic sensor is a photoplethysmography sensor configured to optically measure a blood flow rate from blood vessels and capillaries in a user nose or a user ear lobe, and step 1504 includes identifying a heart rate of the user based on the blood flow rate. In some embodiments, the electromagnetic sensor is an electro-cardiogram sensor, and the signal is a waveform of an electrical pulse controlling a heart rate, and step 1504 includes identifying the heart rate from multiple spikes in the waveform. In some embodiments, the electromagnetic sensor is an electro-encephalogram sensor, the signal is a waveform indicative of a brain activity, and step 1504 includes identifying a characteristic of a neurologic condition in the waveform. In some embodiments, the electromagnetic sensor is an electro-encephalogram sensor including two electrodes disposed on the wearable device in two diametral positions on the user's head, and step 1504 includes assigning the signal to a portion of the user brain between the two diametral positions on the user's head.

Step 1506 includes determining, based on the salient attribute, the health condition of the user of the wearable device. In some embodiments, the wearable device is a headset, and the signal from an electromagnetic sensor that includes an electrocardiogram waveform and a photoplethysmography waveform, and step 1506 further includes identifying a blood transit time between the heart and the head based on a delay between the salient attribute from the electrocardiogram waveform and the salient attribute from the photoplethysmography waveform, and determining a blood pressure for the user of the wearable device based on the blood transit time.

### Hardware Overview

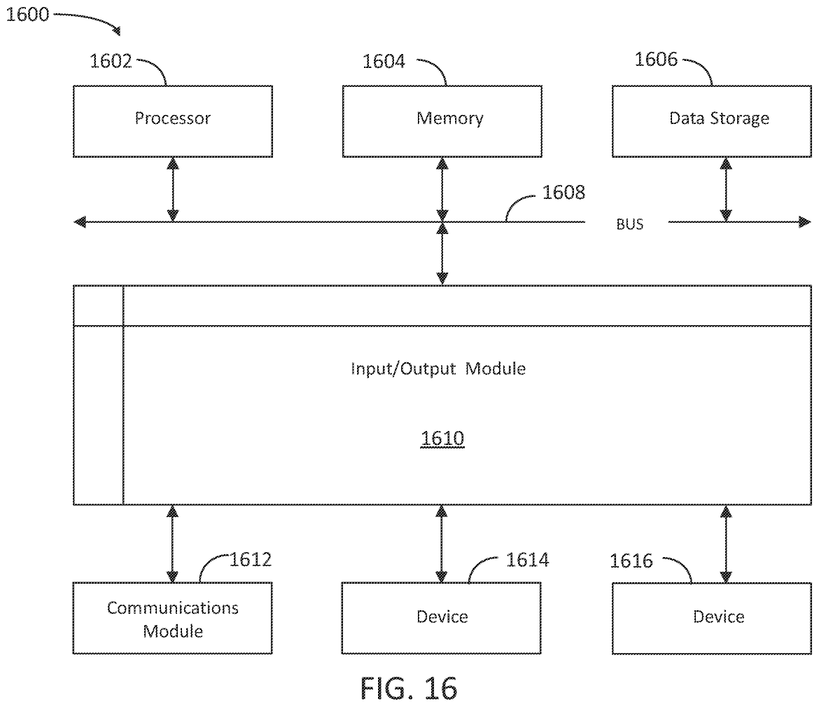

FIG. 16 is a block diagram illustrating an exemplary computer system 1600 with which headsets and other client devices, and methods 1300-1500 can be implemented, according to some embodiments. In certain aspects, computer system 1600 may be implemented using hardware or a combination of software and hardware, either in a dedicated server, or integrated into another entity, or distributed across multiple entities. Computer system 1600 may include a desktop computer, a laptop computer, a tablet, a phablet, a smartphone, a feature phone, a server computer, or otherwise. A server computer may be located remotely in a data center or be stored locally.

Computer system 1600 includes a bus 1608 or other communication mechanism for communicating information, and a processor 1602 coupled with bus 1608 for processing information. By way of example, the computer system 1600 may be implemented with one or more processors 1602. Processor 1602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1600 can include, in addition to hardware, code that creates an execution environment for the computer program in question, e.g., code that constitutes processor firmware, a protocol stack, a database management system, an operating system, or a combination of one or more of them stored in an included memory 1604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1608 for storing information and instructions to be executed by processor 1602. The processor 1602 and the memory 1604 can be supplemented by, or incorporated in, special purpose logic circuitry.

The instructions may be stored in the memory 1604 and implemented in one or more computer program products, e.g., one or more modules of computer program instructions encoded on a computer-readable medium for execution by, or to control the operation of, the computer system 1600, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1604 may also be used for storing temporary variable or other intermediate information during execution of instructions to be executed by processor 1602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1600 further includes a data storage device 1606 such as a magnetic disk or optical disk, coupled with bus 1608 for storing information and instructions. Computer system 1600 may be coupled via input/output module 1610 to various devices. Input/output module 1610 can be any input/output module. Exemplary input/output modules 1610 include data ports such as USB ports. The input/output module 1610 is configured to connect to a communications module 1612. Exemplary communications modules 1612 include networking interface cards, such as Ethernet cards and modems. In certain aspects, input/output module 1610 is configured to connect to a plurality of devices, such as an input device 1614 and/or an output device 1616. Exemplary input devices 1614 include a keyboard and a pointing device, e.g., a mouse or a trackball, by which a consumer can provide input to the computer system 1600. Other kinds of input devices 1614 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1616 include display devices, such as an LCD (liquid crystal display) monitor, for displaying information to the consumer.

According to one aspect of the present disclosure, headsets and client devices can be implemented, at least partially, using a computer system 1600 in response to processor 1602 executing one or more sequences of one or more instructions contained in memory 1604. Such instructions may be read into memory 1604 from another machine-readable medium, such as data storage device 1606. Execution of the sequences of instructions contained in main memory 1604 causes processor 1602 to perform the process steps described herein. One or more processors in a multi-processing arrangement may also be employed to execute the sequences of instructions contained in memory 1604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1600 can include clients and servers. A client and server are generally remote from each other and typically interact through a communication network. The relationship of client and server arises by virtue of computer programs running on the respective computers and having a client-server relationship to each other. Computer system 1600 can be, for example, and without limitation, a desktop computer, laptop computer, or tablet computer. Computer system 1600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1602 for execution. Such a medium may take many forms, including, but not limited to, non-volatile media, volatile media, and transmission media. Non-volatile media include, for example, optical or magnetic disks, such as data storage device 1606. Volatile media include dynamic memory, such as memory 1604. Transmission media include coaxial cables, copper wire, and fiber optics, including the wires forming bus 1608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A device, comprising:
a frame, providing mechanical support to at least two eyepieces;
a capacitive sensor mounted on the frame;
an inertial measurement sensor mounted on the frame; and
a flexible circuit component inside the frame and electrically coupling the capacitive sensor and the inertial measurement sensor with a processor circuit and a memory circuit inside the frame.

2. The device of claim 1, further comprising a touch sensor configured to identify a wearing of the device by a user by contacting at least one portion of a head of the user.

3. The device of claim 1, further comprising one or more haptic actuators configured to provide a touch sensation to a user based on a user input to the capacitive sensor.

4. The device of claim 1, wherein the capacitive sensor includes a linear array of capacitive pads configured to identify a swiping motion of a user finger.

5. The device of claim 1, wherein the capacitive sensor includes a linear array of capacitive pads, and the processor circuit is configured to identify a direction and a speed of a swiping motion of a user finger.

6. The device of claim 1, wherein the capacitive sensor includes a two-dimensional array of capacitive pads configured to identify a swiping motion of a user finger.

7. The device of claim 1, wherein the capacitive sensor includes a two-dimensional array of capacitive pads, and the processor circuit is configured to identify a two-dimensional direction and a speed of a swiping motion of a user finger.

8. The device of claim 1, wherein the capacitive sensor comprises a first array sensor configured to detect a swipe signal, and a contact sensor configured to detect a contact signal with a user face, wherein the first array sensor and the contact sensor are mounted on different portions of the frame.

9. The device of claim 1, further comprising a memory circuit storing multiple instructions and a processor circuit configured to execute the instructions to identify a user commend from a signal from the capacitive sensor and a signal from the inertial measurement sensor.

10. The device of claim 1, further comprising a memory circuit storing multiple instructions and a processor circuit configured to execute the instructions to identify a waveform with a signal from the capacitive sensor and a waveform with a signal from the inertial measurement sensor to distinguish a swiping motion from a tapping motion from a user.

11. A computer-implemented method, comprising:
receiving, from a touch sensor mounted on a frame of a headset, a first touch signal above a first threshold value;
receiving, from an inertial measurement unit mounted on the frame of the headset, a motion signal indicative of a motion of the headset; and
identifying a user command to the headset based on a time overlap between the first touch signal and the motion signal.

12. The computer-implemented method of claim 11, further comprising receiving a second touch signal from a contact sensor, the second touch signal indicative that the headset is worn properly, and wherein identifying the user command comprises verifying that the headset is worn properly.

13. The computer-implemented method of claim 11, wherein the first touch signal is a swipe signal, and identifying a user command to the headset comprises identifying a speed and direction of the swipe signal to verify the user command to the headset.

14. The computer-implemented method of claim 11, further comprising verifying that the motion signal is above a second threshold value.

15. The computer-implemented method of claim 11, wherein identifying the user command comprises identifying the motion signal as a tap, and identifying the first touch signal as a swipe command subsequent to the tap.

16. A computer-implemented method, comprising:
receiving a signal from a sensor, the signal being indicative of a position and a motion of a user of a wearable device;
determining, based on the signal, an activity that the user is engaged in; and
assessing an intensity value to the activity based on an attribute extracted from the signal.

17. The computer-implemented method of claim 16, wherein the wearable device is a smart glass, and receiving the signal from a sensor comprises receiving a signal indicative that the user is wearing the smart glass.

18. The computer-implemented method of claim 16, wherein the wearable device includes a wrist-band device worn by the user, further comprising correlating the signal from the wrist-band device with a signal from a smart glass worn by the user.

19. The computer-implemented method of claim 16, further comprising identifying a pose of the user based on the signal.

20. The computer-implemented method of claim 16, further comprising extracting the attribute from the signal based on a pattern identified in the signal with a machine learning algorithm.
